(19) United States
(12) Patent Application Publication
(10) Pub. No.: US 2026/0122750 A1
(43) Pub. Date: Apr. 30, 2026

(54) FLEXIBLE PLASMA GENERATOR AND METHOD FOR MANUFACTURING FLEXIBLE PLASMA GENERATOR

(71) Applicant: KOREA ADVANCED INSTITUTE OF SCIENCE AND TECHNOLOGY, Daejeon (KR)

(72) Inventors: Hyoungsoo KIM, Daejeon (KR); Wonho CHOE, Daejeon (KR); Jeongsu PYEON, Daejeon (KR); Seong-Cheol Huh, Daejeon (KR)

(21) Appl. No.: 19/306,736

(22) Filed: Aug. 21, 2025

(30) Foreign Application Priority Data
Oct. 28, 2024 (KR) 10-2024-0148262

(51) Int. Cl. H05H 1/24

(52) U.S. Cl. CPC H05H 1/2441

(57) ABSTRACT

A flexible plasma generator is disclosed. The flexible plasma generator according to one aspect of the present disclosure includes: a dielectric substrate capable of elastic deformation; a first electrode formed on one surface of the dielectric substrate and being deformable and restorable in accordance with deformation of the dielectric substrate; and a second electrode formed on an opposite surface of the dielectric substrate and being deformable and restorable in accordance with deformation of the dielectric substrate. Plasma may be generated when an alternating current (AC) power source or a pulsed power source is applied to the first electrode and the second electrode.

### CROSS-REFERENCE TO RELATED APPLICATIONS

This application claims priority to and benefits of Korean Patent Application No. 10-2024-0148262, filed on October 28, 2024, which is incorporated by reference herein in its entirety.

### BACKGROUND

### 1. Technical Field

The present disclosure relates to a flexible plasma generator and a method for manufacturing a flexible plasma generator.

### 2. Description of the Related Art

Plasma-based surface treatment technology, which utilizes the high reactivity of plasma states to treat target surfaces, is widely employed. Plasma may be generated under vacuum, atmospheric pressure, or ambient conditions, and is generally classified as high-temperature plasma, which is characterized by a mean temperature reaching tens of thousands of degrees Celsius and a high degree of ionization, or low-temperature plasma, which is characterized by a mean temperature slightly above room temperature and a relatively low degree of ionization.

Low-temperature plasma is particularly useful in various fields such as etching and deposition in semiconductor processing, surface treatment of metals or polymers, and synthesis of novel materials.

However, conventional atmospheric-pressure low-temperature plasma devices are limited in their ability to apply plasma to surfaces with complex geometries, and a single device is often difficult to utilize across multiple applications. Thus, there is a strong demand for atmospheric-pressure low-temperature plasma generation technology that is flexibly deformable and easily extendable or contractible.

### SUMMARY

An object of the present disclosure is to provide a flexible plasma generator and a method for manufacturing such a generator, which is capable of forming plasma that can conform to various shapes.

According to one aspect of the disclosure, there is provided a flexible plasma generator including: a dielectric substrate capable of elastic deformation; a first electrode formed on one surface of the dielectric substrate and being deformable and restorable in accordance with deformation of the dielectric substrate; and a second electrode formed on an opposite surface of the dielectric substrate and being deformable and restorable in accordance with deformation of the dielectric substrate. Plasma is generated when an alternating current (AC) power source or a pulsed power source is applied to the first and second electrodes.

The first and second electrodes may include liquid metal sintered in plural-particulate form and a thickening agent bonded to a surface of the liquid metal.

The first and second electrodes may be formed by coating the liquid metal in the form of an ink in a liquid state onto the dielectric substrate and allowing the liquid metal to self-sinter.

The first and second electrodes may formed in a single-layer structure in which the thickening agent is interposed between the liquid metal particles.

A polymer may be interposed between the liquid metal and the thickening agent.

The flexible plasma generator may further include a substrate deformation unit configured to apply a physical force to the dielectric substrate, wherein the substrate deformation unit may deform the dielectric substrate to vary the amount of plasma generated.

The substrate deformation unit may include a pressure chamber configured to create a pressure differential between the one surface and the opposite surface of the dielectric substrate to deform the dielectric substrate.

According to another aspect of the present disclosure, there is provided a method for manufacturing a flexible plasma generator, the method including: a substrate placement step of positioning a dielectric substrate capable of elastic deformation; a first electrode formation step of forming a first electrode on one surface of the dielectric substrate by applying a liquid metal slurry ink that self-sinters upon solvent evaporation; and a second electrode formation step of forming a second electrode on an opposite surface of the dielectric substrate by applying the liquid metal slurry ink.

The method may further include a slurry ink preparation step of preparing the self-sintering liquid metal slurry ink, wherein the slurry ink preparation step may include: a liquid metal dispersion step of mixing liquid metal with the solvent to disperse the liquid metal in the solvent; a composite formation step of adding a thickening agent to the solvent to form a composite of the liquid metal and the thickening agent; and a slurry formation step of allowing the composite to settle to form a slurry.

The method may further include an oxide layer removal step of removing an oxide layer from the liquid metal mixed in the solvent. The oxide layer removal step may include a step of adding an acid to the solvent.

The method may further include a dispersion stabilization step of stabilizing dispersion of the liquid metal mixed in the solvent. The dispersion stabilization step may include a step of adding a polymer to control dispersibility of the dispersed liquid metal.

The liquid metal dispersion step may include a primary ultrasonic treatment step of dispersing the liquid metal by applying an ultrasonic treatment to the solvent.

The method may further include a secondary ultrasonic treatment step of applying an ultrasonic treatment to the solvent before the slurry formation step.

According to embodiments of the present disclosure, the electrodes may deform and restore in accordance with deformation of the dielectric substrate, thereby enabling the formation of plasma in various shapes.

### BRIEF DESCRIPTION OF THE DRAWINGS

These and/or other features will become apparent and more readily appreciated from the following description of the embodiments, taken in conjunction with the accompanying drawings.

FIG. 1 is a diagram showing a flexible plasma generator according to an embodiment of the present disclosure.

FIGS. 2 and 3 are diagrams showing the first and second electrode in the flexible plasma generator according to an embodiment of the present disclosure.

FIGS. 4A to 5C are diagrams showing the results of stability tests of the flexible plasma generator according to an embodiment of the present disclosure.

FIGS. 6 to 8 are photographs showing the characteristics of the first and second electrodes under tensile strain in the flexible plasma generator according to an embodiment of the present disclosure.

FIGS. 9 to 13 are graphs showing the characteristics of the first and second electrodes under tensile strain in the flexible plasma generator according to an embodiment of the present disclosure.

FIGS. 14 to 19 are diagrams illustrating a substrate deformation unit in the flexible plasma generator according to an embodiment of the present disclosure.

FIGS. 20 to 26 are diagrams illustrating the slurry ink preparation step in the method for manufacturing a flexible plasma generator according to an embodiment of the present disclosure.

FIG. 27 is a diagram showing a composite of liquid metal and a thickening agent formed in the slurry ink preparation step of the method for manufacturing a flexible plasma generator according to an embodiment of the present disclosure.

FIG. 28 is a diagram showing polymer capping of liquid metal in the slurry ink preparation step of the method for manufacturing a flexible plasma generator according to an embodiment of the present disclosure.

FIG. 29 is a diagram illustrating the self-sintering of liquid metal slurry ink prepared in the slurry ink preparation step of the method for manufacturing a flexible plasma generator according to an embodiment of the present disclosure.

### DETAILED DESCRIPTION

The terminology used herein is for the purpose of describing particular embodiments only and is not intended to limit the disclosure thereto. As used herein, the singular forms “a,” “an,” and “the” are intended to include the plural forms as well, unless the context clearly indicates otherwise.

It should also be understood that when a component is described as “comprising” or “including” another component, this does not exclude the presence of additional components, unless explicitly stated otherwise. Furthermore, the term “on” as used throughout the specification and claims refers to a relative position and may mean either “above” or “below” the referenced element, and does not necessarily imply a direction relative to gravity.

The term “coupled” or “connected” as used herein is intended to encompass the concepts of both direct physical contact and indirect contact where an intervening component is present between the coupled components.

Moreover, terms such as “first,” “second,” and the like may be used to describe various elements, but these terms should not be construed as limiting. These terms are merely used to distinguish one element from another.

The sizes and thicknesses of elements illustrated in the drawings may be exaggerated for convenience and clarity of explanation, and the disclosure is not necessarily limited to the relative proportions shown in the drawings.

Hereinafter, embodiments of the flexible plasma generator and the method for manufacturing the flexible plasma generator according to the present disclosure will be described in detail with reference to the accompanying drawings. In the drawings, the same or corresponding elements are denoted by the same reference numerals, and redundant descriptions thereof may be omitted.

FIG. 1 illustrates a flexible plasma generator according to an embodiment of the present disclosure. Referring to FIG. 1, the flexible plasma generator according to an embodiment of the embodiment includes a dielectric substrate 50, a first electrode 100, and a second electrode 200.

The dielectric substrate 50 is made of a dielectric material and is capable of elastic deformation. Being an insulator, the dielectric does not allow charges to pass through; instead, negative charges within the dielectric align in response to positive charges, and positive charges align in response to negative charges, thereby imparting polarity. Accordingly, the potential difference of the electric field is reduced by as much as the dielectric constant of the dielectric material, and the dielectric may store energy corresponding to the reduced potential difference.

Referring to FIG. 1, the dielectric substrate 50 of the present embodiment has a planar structure and is positioned between the first electrode 100 and the second electrode 200, and thus may serve to store charges escaping from the plasma to the electrodes on its surface and to emit secondary electrons. The dielectric substrate 50 may be formed with an appropriate thickness, depending on the dielectric material constituting the dielectric substrate 50, to enable stable plasma discharge.

In particular, the dielectric substrate 50 of the present embodiment may be capable of elastic deformation. Accordingly, the dielectric substrate 50 may be stretched or contracted in various directions and may be deformed into various shapes.

For example, the dielectric substrate 50 of the present embodiment may include at least one material selected from silicone rubber, nitrile rubber, polyvinyl chloride (PVC), polyethylene terephthalate (PET), waterborne polyurethane (WPU), polydimethylsiloxane (PDMS), and natural rubber (latex).

The first electrode 100 and the second electrode 200 are formed on opposing surfaces of the dielectric substrate 50 and generate a potential difference necessary for plasma discharge.

As illustrated in FIG. 1, the first electrode 100 may be formed on one surface of the dielectric substrate 50, and the second electrode 200 may be formed on the opposite surface of the dielectric substrate 50. Accordingly, a dielectric barrier discharge (DBD) structure of plasma discharge may be formed, wherein plasma can be generated by applying an alternating current (AC) power source 300 or a pulsed power source to the first electrode 100 and the second electrode 200.

In the DBD structure of plasma discharge, when AC or pulsed power is applied to the electrodes, charges accumulate on the surface of the dielectric material surrounding the electrodes. Then, when the polarity of the electrodes is reversed, the charges stored on the dielectric surface are released, generating plasma between the electrodes. This configuration allows for plasma discharge even at atmospheric pressure.

In particular, the first electrode 100 and the second electrode 200 of the present embodiment may be capable of deforming and recovering in accordance with the deformation of the dielectric substrate 50. For example, when the dielectric substrate 50 is stretched, the first electrode 100 and the second electrode 200 may also elongate, and when the dielectric substrate 50 returns to its original shape, the first electrode 100 and the second electrode 200 may similarly recover their original shapes. Likewise, the first electrode 100 and the second electrode 200 may be compressed when the dielectric substrate 50 is compressed, and may return to their original configurations when the dielectric substrate 50 is no longer compressed.

Specifically, the first electrode 100 and the second electrode 200 may include liquid metal sintered in plural-particulate form and a thickening agent bonded to the surface of the liquid metal, thereby enabling the electrodes to undergo stretching or compression while maintaining shape recovery capability.

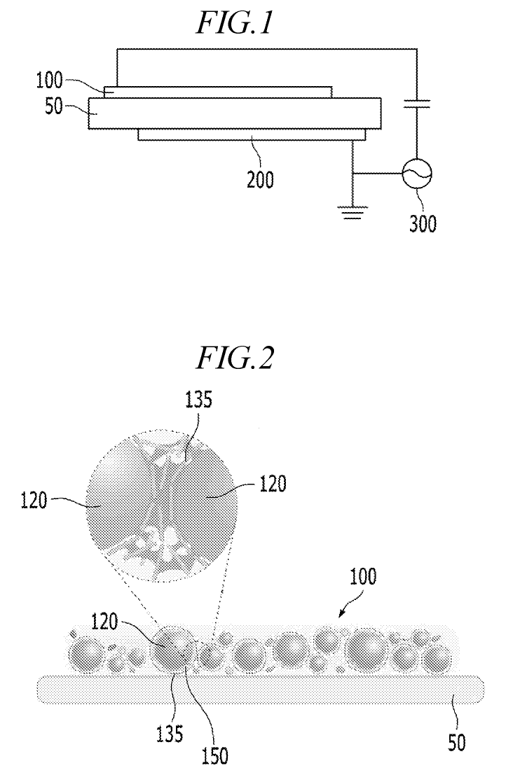

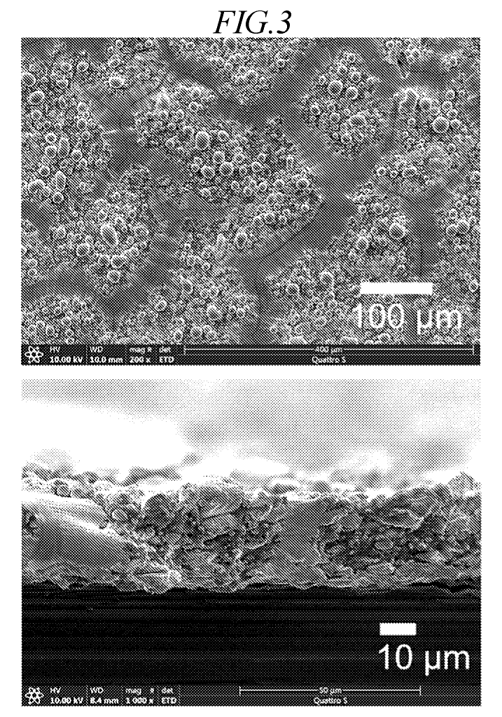

FIGS. 2 and 3 illustrate the first electrode 100 in the flexible plasma generator according to an embodiment of the present disclosure. FIG. 3 shows front and side views of the first electrode 100 captured by scanning electron microscopy (SEM).

Referring to FIGS. 2 and 3, the first electrode 100 and the second electrode 200 of the present embodiment may include liquid metal 120 sintered in plural-particulate form and a thickening agent 135 bonded to the surface of the liquid metal 120. The first electrode 100 and the second electrode 200 may be formed by coating the liquid metal in the form of a liquid ink onto the dielectric substrate 50 and allowing it to self-sinter. In particular, the first electrode 100 and the second electrode 200 may have a single-layer structure in which the thickening agent 135 is interposed between particles of the liquid metal 120.

The liquid metal 120 may include gallium-based metals, which have low melting points and can remain in a liquid state at room temperature. However, the liquid metal 120 is not limited to gallium-based metals and may include any electrically conductive metal exhibiting liquid-like flow properties.

The thickening agent 135 may include materials such as polysaccharides (e.g., xanthan gum, hyaluronic acid, carrageenan, etc.), polyacrylic acid (PAA), water-soluble polyacrylates (e.g., sodium polyacrylate, potassium polyacrylate, etc.), and water-soluble synthetic layered clay minerals (e.g., Laponite, hectorite, etc.).

For example, in the first electrode 100 and the second electrode 200 of the present embodiment, the liquid metal 120 may form interconnected structures both directly and through Laponite particles 135, which act as thickening agents 130. The liquid metal 120 may sinter in particulate form, creating a structure in which particles of liquid metal 120 are directly connected, as well as a structure in which the particles are connected via the thickening agent 130 bonded to the surfaces of the liquid metal 120. The formation of this structure, in which the thickening agent 130 is interposed between particles of the liquid metal 120, will be described in more detail in the embodiments of the method for manufacturing the flexible plasma generator.

In addition, the first electrode 100 and the second electrode 200 of the present embodiment may have a structure in which a polymer 150 is interposed between the liquid metal 120 and the thickening agent 130. For example, the first electrode 100 and the second electrode 200 may include a structure in which polyvinylpyrrolidone is interposed between the liquid metal 120 and Laponite particles 135. That is, a structure may be formed in which the polymer 150 is interposed between the liquid metal 120 and the thickening agent 130.

Referring to FIG. 3, the first electrode 100 formed from the liquid metal ink shows a homogeneous distribution of Laponite, confirming that no bilayer structure of Laponite, in which Laponite is separated as a layer, is formed due to density differences. Instead, the first electrode 100 is confirmed to have a single-layer structure in which the liquid metal 120 and the thickening agent 130 are combined.

The first electrode 100 and the second electrode 200 of the present embodiment may undergo stretching or compression along with deformation of the dielectric substrate 50 and may recover the original shapes of the first electrode 100 and the second electrode 200 when the dielectric substrate 50 returns to its original form. Notably, even after stretching or compression and subsequent recovery, the electrical and physical properties, such as electrical resistance, of the first electrode 100 and the second electrode 200 may remain substantially unchanged.

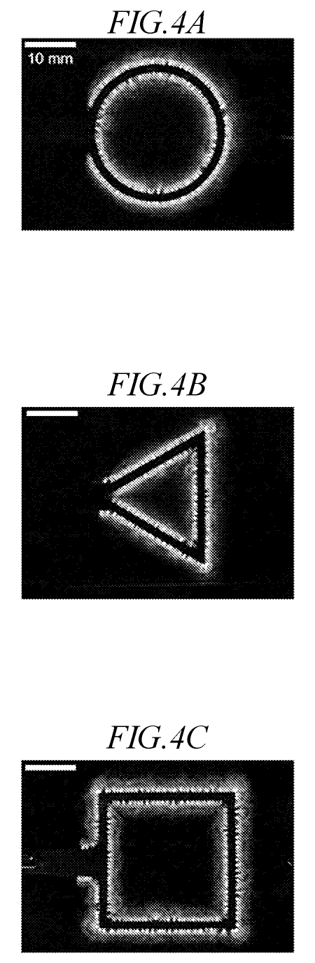

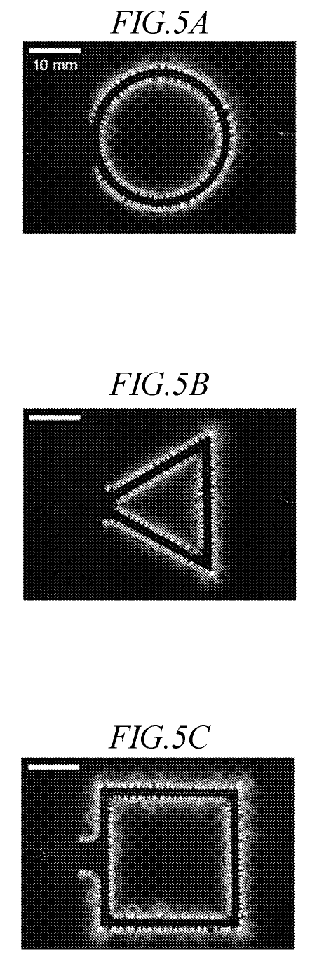

FIGS. 4A to 5C illustrate the results of stability testing of the flexible plasma generator according to an embodiment of the present disclosure. Referring to FIG. 4, in the flexible plasma generator of the present embodiment, the first electrode 100 is applied in the form of a liquid ink and may be formed in various shapes. Accordingly, plasma may be generated in a variety of forms.

Referring to FIGS. 4A to 5C, a comparison between plasma generation on the first day after forming the first electrode 100 (FIGS. 4A to 4C) and plasma generation 137 days after forming the first electrode 100 (FIGS. 5A to 5C) confirms that the plasma generation performance is substantially unchanged over time.

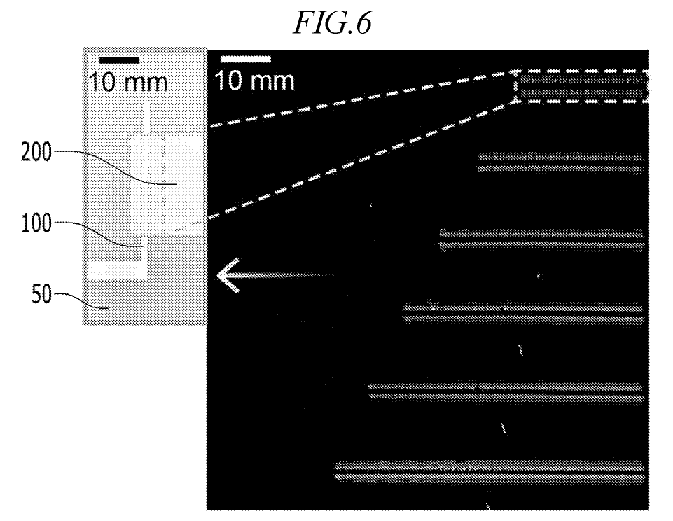

FIGS. 6 to 8 are photographs showing the characteristics of the first electrode 100 and the second electrode 200 under tensile strain in the flexible plasma generator according to an embodiment of the present disclosure. Referring to FIG. 6, the rod-shaped portion of the first electrode 100, which has an L-shaped structure, and the second electrode 200, which has a rectangular structure, are arranged in an overlapping manner, such that plasma may be generated at the rod-shaped portion of the first electrode 100.

In FIG. 6, an alternating current of 3 kHz and 7 kV is applied between the first electrode 100 and the second electrode 200. In FIG. 7, an alternating current of 5 kHz and 7 kV is applied between the first electrode 100 and the second electrode 200, and in FIG. 8, an alternating current of 5 kHz and 6 kV is applied between the first electrode 100 and the second electrode 200.

Referring to FIGS. 6 to 8, when the dielectric substrate 50 is stretched in the longitudinal direction of the rod-shaped portion of the first electrode 100, the first electrode 100 and the second electrode 200 may be elongated together. As the first electrode 100 and the second electrode 200 are stretched, the plasma elongates accordingly and is formed along the stretched first electrode 100 and second electrode 200. Notably, as the dielectric substrate 50 is stretched and the length of the plasma increases, the intensity of the plasma generation is observed to increase.

Comparing FIG. 6 and FIG. 7, it can be seen that increasing the frequency of the alternating current applied between the first electrode 100 and the second electrode 200 results in enhanced plasma generation.

Comparing FIG. 7 and FIG. 8, it can be seen that decreasing the voltage of the alternating current applied between the first electrode 100 and the second electrode 200 results in reduced plasma generation.

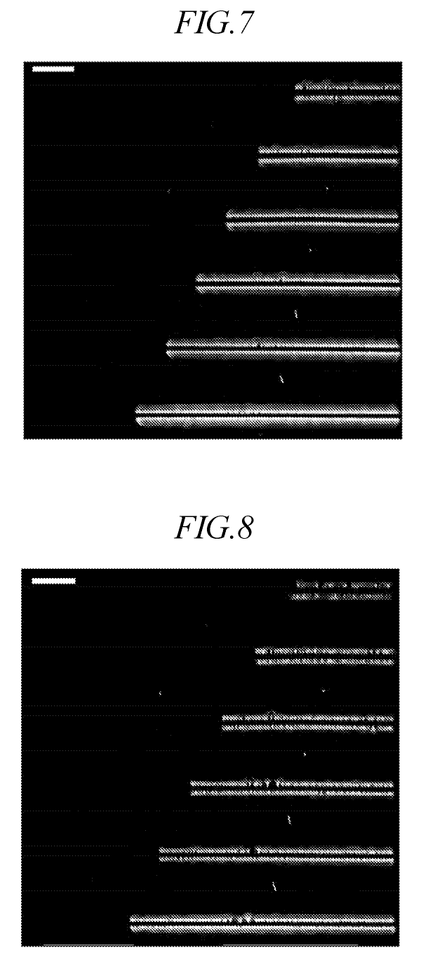

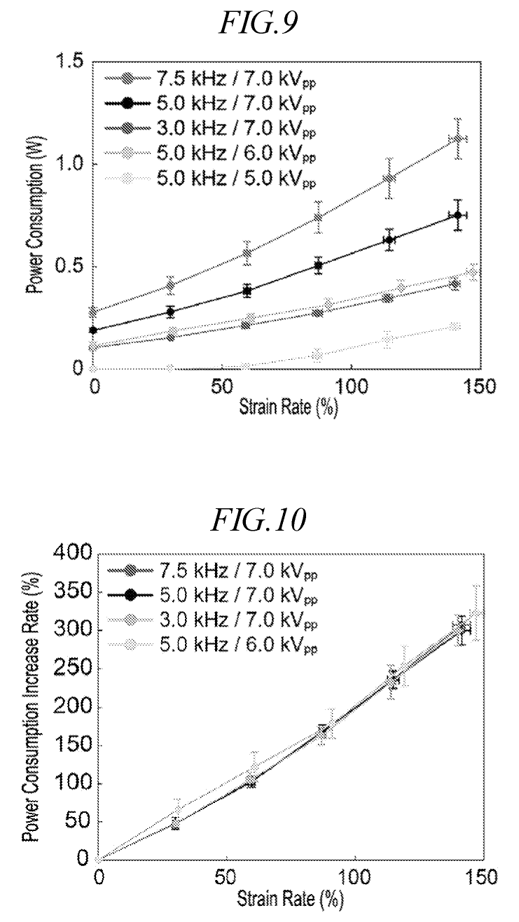

FIGS. 9 to 13 are graphs showing the characteristics of the first electrode 100 and the second electrode 200 under tensile strain in the flexible plasma generator according to an embodiment of the present disclosure. The first electrode 100 and the second electrode 200 have the same structure as those illustrated in FIG. 6.

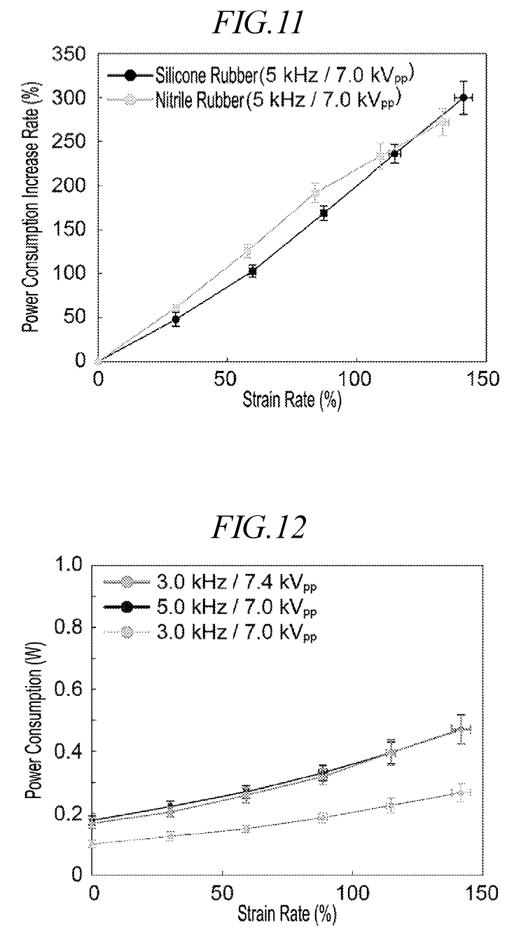

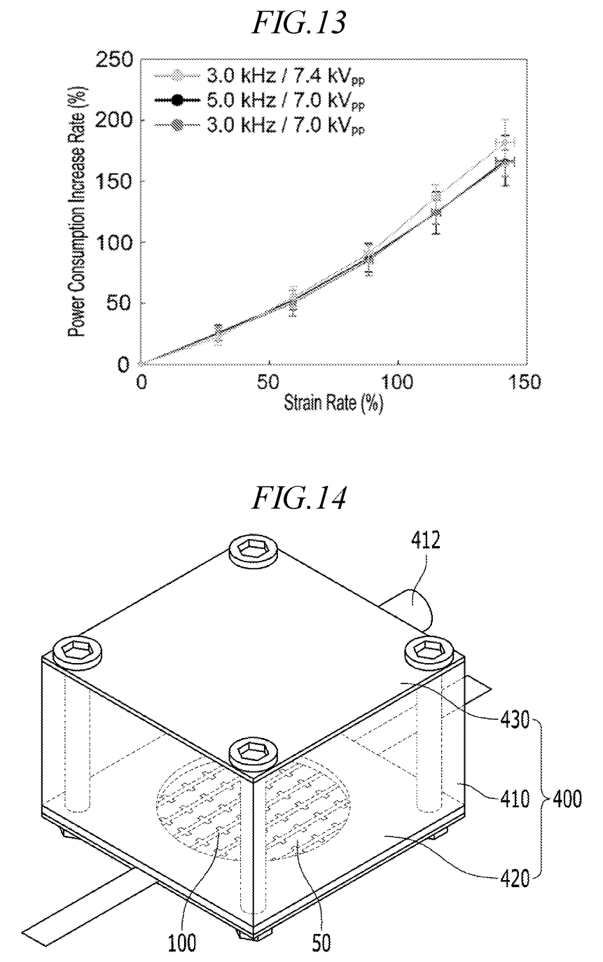

FIGS. 9 to 11 are graphs showing the results when the dielectric substrate 50 is stretched in the longitudinal direction of the rod-shaped portion of the first electrode 100. FIGS. 12 and 13 are graphs showing the results when the dielectric substrate 50 is stretched at a 45-degree angle relative to the longitudinal direction of the rod-shaped portion of the first electrode 100.

Referring to FIGS. 9 to 13, as the strain rate of the dielectric substrate 50 increases, both the power consumption and the rate of increase in power consumption are observed to increase. Accordingly, it can be seen that as the dielectric substrate 50 is stretched, the thickness of the dielectric substrate 50 decreases, and as the thickness of the dielectric substrate 50 decreases, the power consumption tends to increase.

Referring to FIGS. 9 and 12, the power consumption is observed to increase as the discharge voltage increases. Additionally, the power consumption is also observed to increase as the discharge frequency increases.

Referring to FIGS. 10 and 13, the rate of increase in power consumption is observed to be approximately linearly proportional to the strain rate of the dielectric substrate 50.

The flexible plasma generator of the present embodiment may further include a substrate deformation unit 400 configured to apply physical force to the dielectric substrate 50.

FIGS. 14 to 19 illustrate the substrate deformation unit 400 in the flexible plasma generator according to an embodiment of the present disclosure.

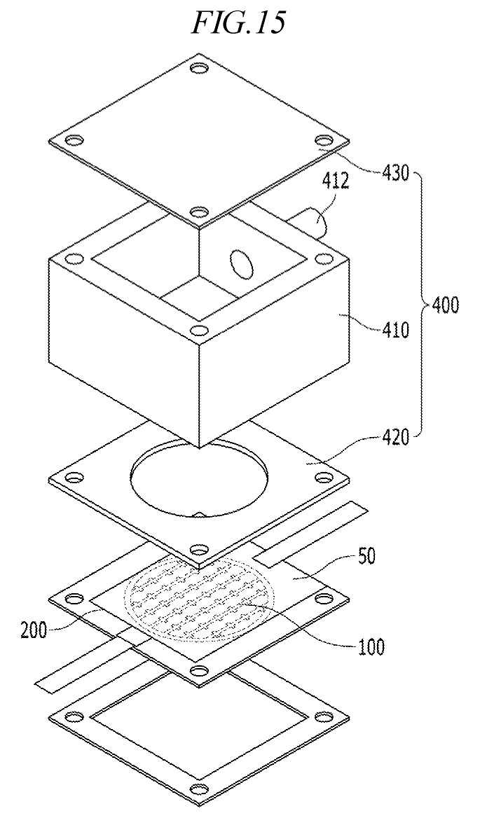

Referring to FIGS. 14 and 15, the substrate deformation unit 400 may include a pressure chamber configured to establish a pressure difference between one surface and an opposite surface of the dielectric substrate 50, thereby deforming the dielectric substrate 50. The pressure chamber of the present embodiment may include a body 410 that defines an internal space passing vertically through the body 410, and first and second covers 420, 430 that seal the internal space by covering the upper and lower surfaces of the body 410. A through-hole may be formed in the first cover 420, and the dielectric substrate 50 of the flexible plasma generator may be installed over the through-hole of the first cover 420. Accordingly, by removing or supplying air in the pressure chamber through an air passage 412 connected to the body, a force may be applied to pull the dielectric substrate 50 into the internal space of the pressure chamber or to push the dielectric substrate 50 outward from the internal space.

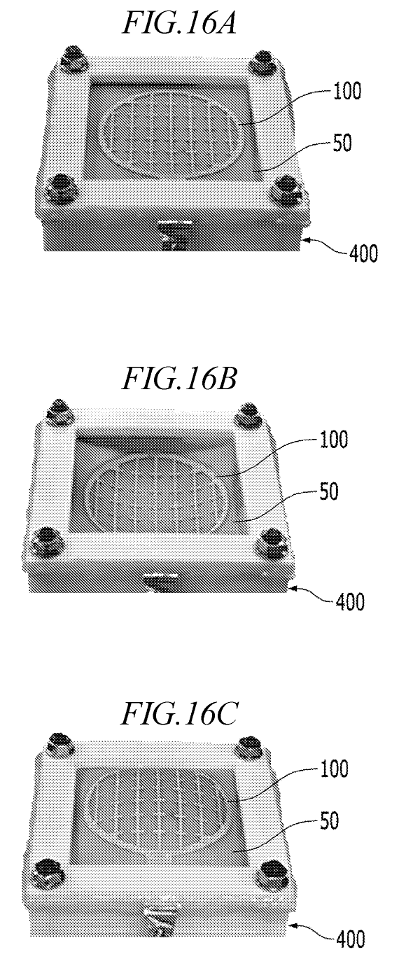

Referring to FIGS. 16A to 19, the dielectric substrate 50 of the present embodiment may be installed such that the opposite surface is attached to the first cover 420 and the one surface is exposed to the outside (see FIG. 16A and FIG. 17).

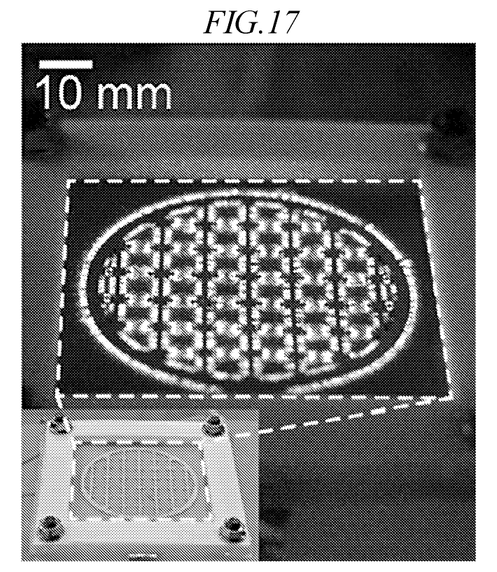

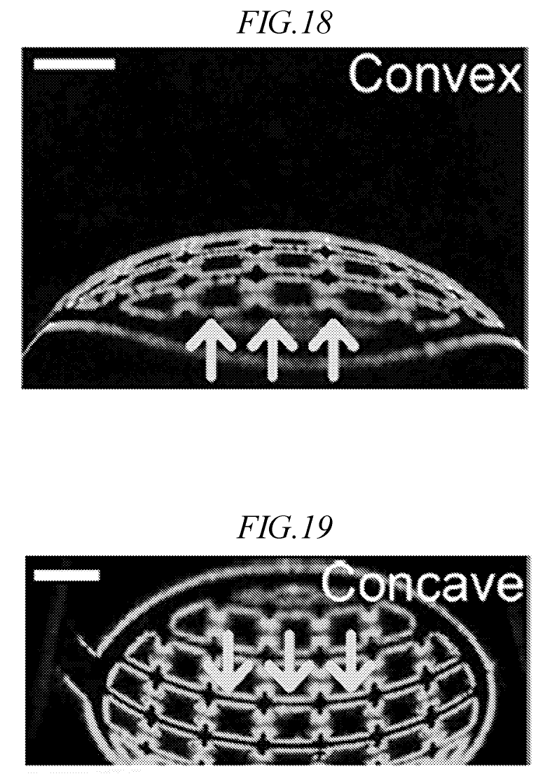

When air is removed from the internal space of the pressure chamber, the dielectric substrate 50 may be drawn into the internal space and deformed into a concave shape. The first electrode 100 and the second electrode 200 may also deform into concave shapes following the deformation of the dielectric substrate 50, and plasma may be generated along the concave surface of the first electrode 100 (see FIG. 16B and FIG. 18).

Conversely, when air is supplied into the internal space of the pressure chamber, the dielectric substrate 50 may be pushed outward from the internal space of the pressure chamber and deformed into a convex shape. The first electrode 100 and the second electrode 200 may also deform into convex shapes along with the dielectric substrate 50, and plasma may be generated along the convex surface of the first electrode 100 (see FIG. 16C and FIG. 19).

The substrate deformation unit 400 may deform the dielectric substrate 50 to vary the amount of plasma generated. As described above, the flexible plasma generator of the present embodiment may adjust the tensile strain of the dielectric substrate 50 to regulate power consumption, and the adjustment of power consumption may, in turn, vary the amount of plasma generated.

In another aspect of the present disclosure, the method for manufacturing a flexible plasma generator according to an embodiment includes a substrate placement step (S110), a first electrode formation step (S120), and a second electrode formation step (S130).

In the substrate placement step (S110), a dielectric substrate 50 capable of elastic deformation is positioned. As described above, the dielectric substrate 50 of the present embodiment may have a planar structure and may be positioned such that either one surface or an opposite surface thereof rests on a supporting surface.

In the first electrode formation step (S120) and the second electrode formation step (S130), the first electrode 100 and the second electrode 200 are respectively formed on the one surface and the opposite surface of the dielectric substrate 50.

In the first electrode formation step (S120) of the present embodiment, the first electrode 100 may be formed on the one surface of the dielectric substrate 50 using a liquid metal slurry ink that self-sinters as the solvent evaporates.

In the second electrode formation step (S130) of the present embodiment, the second electrode 200 may be formed on the opposite surface of the dielectric substrate 50 using the liquid metal slurry ink.

The method for manufacturing the flexible plasma generator may further include a slurry ink preparation step (S100) of preparing the self-sintering liquid metal slurry ink.

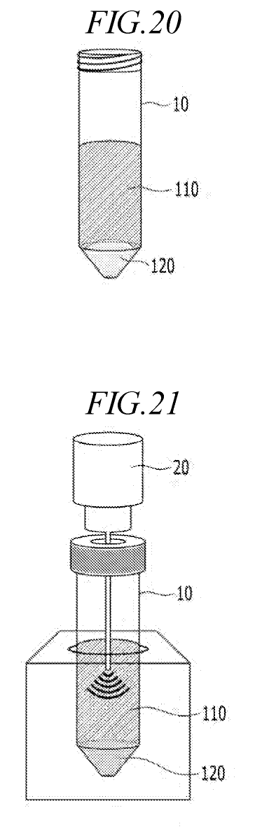

FIGS. 20 to 26 illustrate the slurry ink preparation step in the method for manufacturing a flexible plasma generator according to an embodiment of the present disclosure.

Referring to FIGS. 20 to 26, the slurry ink preparation step (S100) in the present embodiment is a step of preparing a liquid metal slurry ink that self-sinters as solvent 110 evaporates. The slurry ink preparation step (S100) may include a liquid metal dispersion step (S102), a composite formation step (S104), and a slurry formation step (S106).

In the liquid metal dispersion step (S102), liquid metal 120 is mixed with the solvent 110 to disperse the liquid metal 120 in the solvent 110.

Referring to FIG. 20, the solvent 110 and the liquid metal 120 may be introduced into a container 10. For example, a mixed solution of ethanol and water may be used as the solvent 110, and liquid metal 120 may be added to the ethanol-water mixture. The liquid metal 120 may include gallium-based metals, which have low melting points and thus can remain in a liquid state at room temperature. The solvent 110 is not limited to the aforementioned example, and various solvents, such as aqueous ethanol solutions, methanol, ethanol, and other alcohols, may also be used. Similarly, the liquid metal 120 is not limited to gallium-based metals and may include any electrically conductive metals exhibiting liquid-like flow properties.

Referring to FIG. 21, in the liquid metal dispersion step (S102) of the present embodiment, a primary ultrasonic treatment step may be performed by applying ultrasonic treatment to the solvent 110 containing the liquid metal 120 to disperse the liquid metal 120. An ultrasonic generator 20 may be inserted into the solvent 110 to transmit ultrasonic waves to the solvent 110 and the liquid metal 120. Through the ultrasonic treatment, the liquid metal 120 may be dispersed within the solvent 110 in the form of particles of various sizes, ranging from several hundred nanometers to several micrometers.

It should be understood that the method of dispersing liquid metal 120 is not limited to the above-described example, and the liquid metal 120 may also be dispersed in the solvent 110 by various known methods.

In the composite formation step (S104), a thickening agent 130 is added to the solvent 110 to form a composite of the liquid metal 120 and the thickening agent 130.

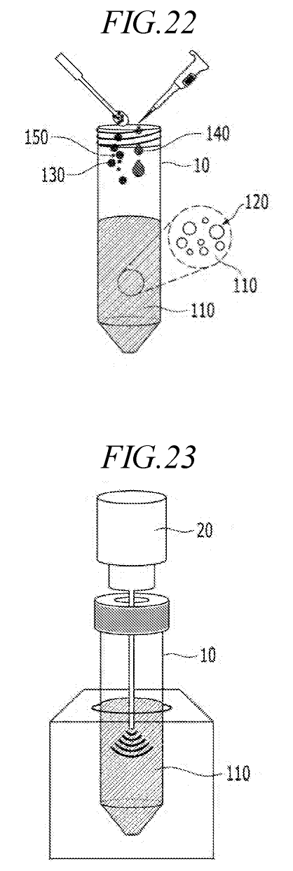

Referring to FIG. 22, in the present embodiment, a thickening agent 130 may be added to the mixture of solvent 110 and liquid metal 120 to form a composite of the liquid metal 120 and the thickening agent 130. The thickening agent 130 is a substance added to increase the viscosity of a solution or mixture, and, in the present embodiment, may form a composite by bonding to the liquid metal 120 and may trap the solvent 110 within the composite.

Accordingly, by varying the amount of thickening agent 130 added, the viscosity of the liquid metal ink can be adjusted. The composite of the liquid metal 120 and the thickening agent 130 may have a trapping effect, in which the solvent 110 is retained within the internal structure of the composite.

For example, in the present embodiment, since a mixed solution of ethanol and water is used as the solvent 110, a water-soluble thickening agent 130 may be employed. The water-soluble thickening agent 130 may include polysaccharides (e.g., xanthan gum, hyaluronic acid, carrageenan, etc.), polyacrylic acid (PAA), water-soluble polyacrylates (e.g., sodium polyacrylate, potassium polyacrylate, etc.), and water-soluble synthetic layered clay minerals (e.g., Laponite, hectorite, etc.).

In the present embodiment, Laponite may be used as the thickening agent 130. Laponite nanoplate powder may be added to the mixture of solvent 110 and liquid metal 120. The viscosity of the liquid metal ink may be adjusted according to the concentration of Laponite.

FIG. 27 illustrates the composite of liquid metal 120 and thickening agent 130 formed in the process of manufacturing the liquid metal ink according to an embodiment of the present disclosure. Referring to FIG. 27, in the present embodiment, plate-shaped particles of Laponite 135 may form a three-dimensional “house of cards” structure and bond with the liquid metal 120 to form a composite. As a result, a trapping effect may be generated in which the solvent 110 is retained within the internal structure of the composite.

Accordingly, an adsorption effect may arise, in which the solvent 110 is confined within the composite of liquid metal 120 and thickening agent 130. This allows the liquid metal ink to achieve a state of high-viscosity slurry 125, inducing slow evaporation of the solvent 110 and preventing the formation of cracks in conductive patterns formed with the liquid metal ink.

However, if the concentration of the thickening agent 130 is excessively high, sedimentation of the composite may not occur in the slurry formation step (S106), which will be described later. Moreover, a high concentration of thickening agent 130 may adversely affect the electrical properties of the conductive patterns formed with the liquid metal ink. Therefore, it is desirable to adjust the concentration of the thickening agent 130 such that the composite of the liquid metal 120 and the thickening agent 130 retains an appropriate amount of solvent 110.

In addition, in the slurry ink preparation step of the present embodiment, an oxide layer removal step may further be included to remove an oxide layer formed on the liquid metal 120 mixed in the solvent 110.

The oxide layer removal step may include a step of adding an acid 140 to the solvent 110. For example, hydrochloric acid may be added to the ethanol-water solvent 110.

If an oxide layer is formed on the surface of the liquid metal 120, particles of the liquid metal 120 may not easily fuse when forming electrodes with the liquid metal ink, preventing the formation of electrical pathways between the electrodes. By removing the oxide layer from the liquid metal particles 120, the particles of liquid metal 120 may be induced to combine with each other when the solvent 110 evaporates, thereby forming conductive pathways.

In addition, the slurry ink preparation step of the present embodiment may further include a dispersion stabilization step for stabilizing the dispersion of the liquid metal 120 mixed in the solvent 110.

The dispersion stabilization step may include adding a polymer 150 to adjust the dispersibility of the dispersed liquid metal 120. Due to the high surface tension of the liquid metal 120 dispersed in the solvent 110, coalescence may occur, leading to a decline in dispersion stability over time. Accordingly, to maintain the state of the liquid metal 120 dispersed in the solvent 110, a polymer 150 capable of capping the liquid metal 120 may be added to the solvent 110. For example, in the present embodiment, polyvinylpyrrolidone may be added to the solvent 110 to stabilize the dispersion of the liquid metal 120.

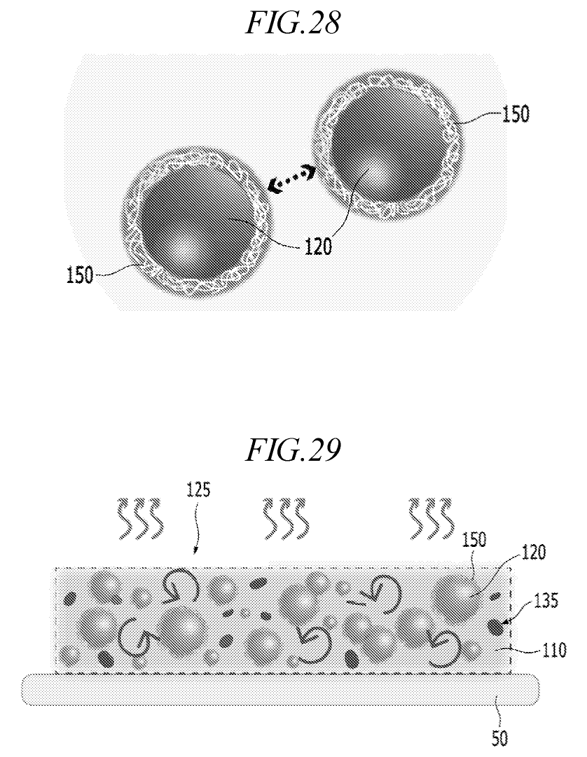

FIG. 28 illustrates the polymer 150 capping the liquid metal 120 in the process of manufacturing the liquid metal ink according to an embodiment of the present disclosure. Referring to FIG. 28, the surface of the liquid metal particles 120 may be surrounded by long-chain molecules of polyvinylpyrrolidone, thereby preventing aggregation of the liquid metal particles 120. When particles of liquid metal 120 are surrounded by long-chain molecules of polymer 150 and approach each other, repulsive forces may be generated. In other words, by adding polyvinylpyrrolidone to the solvent 110, repulsive forces may be generated between the liquid metal 120 particles mixed in the solvent 110, thereby controlling the dispersibility of the liquid metal 120.

If the concentration of the polymer 150 controlling dispersibility is increased, sedimentation of the composite may not occur in the slurry formation step (S106), which will be described later. Accordingly, the amount of polymer 150 added to control the dispersibility of the liquid metal 120 may be adjusted to regulate sedimentation in the slurry and to control the viscosity of the liquid metal ink.

Therefore, it is preferable for the polymer 150 controlling dispersibility to be added in an appropriate concentration that allows sedimentation of the slurry. For example, in the present embodiment, the liquid metal ink may be prepared by optimizing the weight ratio (wt%) of gallium-based liquid metal: ethanol-water solvent: Laponite: polyvinylpyrrolidone to 75.33:21.86:2.34:0.47.

In the slurry formation step (S106), the composite may be allowed to settle to form a slurry 125.

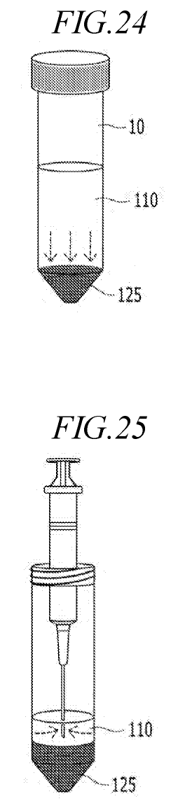

Referring to FIG. 24, in the present embodiment, the solvent 110 in which the composite of liquid metal 120 and thickening agent 130 is mixed may be allowed to settle naturally to form a slurry 125, thereby increasing the viscosity of the liquid metal ink. The slurry 125 may include liquid metal 120 and the composite of liquid metal 120 and thickening agent 130. By adjusting the duration of the sedimentation of the composite, the viscosity of the liquid metal ink can be controlled.

For example, the sedimentation time for the mixture of liquid metal 120 and Laponite composite in the solvent 110 may be optimized to 24 hours to form a slurry 125 containing the Laponite composite.

The Laponite concentration in the slurry 125 may strongly depend on the sedimentation time. If the sedimentation time is excessively long, the concentrations of Laponite and acid in the slurry 125 may decrease. A reduction in the Laponite content may impair the trapping effect for the solvent 110, and a reduction in the acid content may result in insufficient removal of the oxide layer from the surface of the liquid metal 120. This, in turn, may lead to incomplete coalescence of the liquid metal 120 or the formation of cracks in the electrodes formed with the liquid metal ink.

Conversely, if the sedimentation time is too short, the amount of solvent 110 to be removed may be significantly reduced, and the viscosity of the liquid metal ink may not increase sufficiently.

The method may further include a secondary ultrasonic treatment step performed on the solvent 110 before the slurry formation step (S106). The secondary ultrasonic treatment step may be performed after the oxide layer removal step.

If the ultrasonic treatment is performed only once after the oxide layer removal step, the high surface tension of the liquid metal 120 may necessitate the use of high-intensity ultrasonic waves to disperse the liquid metal 120 into particles ranging from several hundred nanometers to several micrometers in size.

Referring to FIGS. 21 and 23, the liquid metal 120 is first dispersed through a primary ultrasonic treatment, followed by removal of the oxide layer, and then is dispersed again through the secondary ultrasonic treatment, thereby reducing excessive use of the ultrasonic device and decreasing the amount of heat generated due to ultrasonic waves.

After the slurry formation step (S106), the method may further include a solvent removal step for removing a portion of the solvent 110.

Referring to FIG. 25, after forming the slurry 125 by allowing the composite to settle, the liquid solvent 110 may be separated and removed to further concentrate the liquid metal 120. Once the liquid metal 120 and the composite have settled to form the slurry 125, the solvent 110 not contained within the slurry 125 may separate into another layer above the slurry 125. By removing the solvent 110 separated to another layer from the slurry, a high-viscosity liquid metal ink can be obtained.

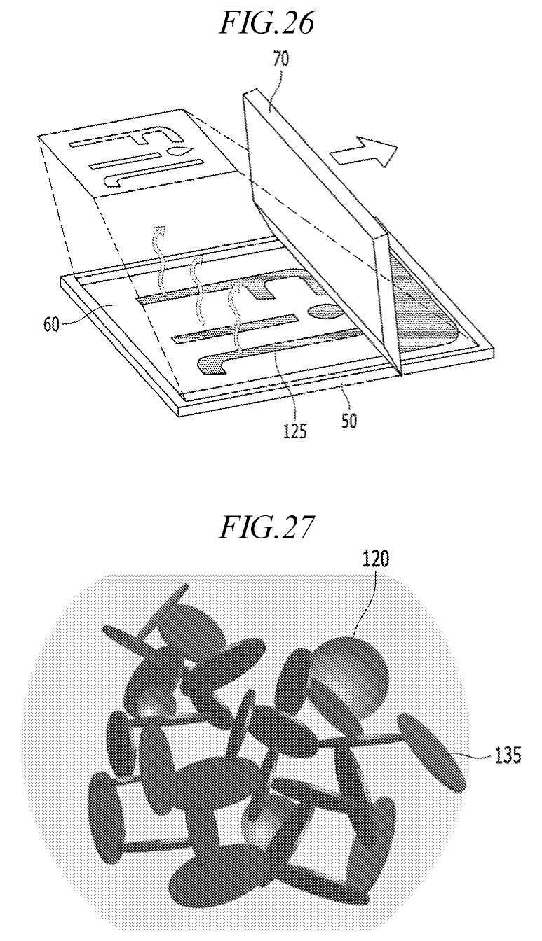

Referring to FIG. 26, since the liquid metal ink of the present embodiment becomes to have a high viscosity, the liquid metal ink may be easily coated ranging from tens of centimeters to tens of microns in size onto the dielectric substrate 50 by brushing, nozzle dispensing, inkjet printing, or other techniques to form conductive patterns such as electrodes.

For example, a pattern mask 60 having the shape of the first electrode 100 of the flexible plasma generator punctured therein may be prepared. The pattern mask 60 may be placed on one surface of the dielectric substrate 50, and the liquid metal ink may be coated to print a conductive pattern. The excess liquid metal ink remaining on the pattern mask 60 may be removed using a blade 70. Then, by removing the pattern mask 60 from the surface of the dielectric substrate 50, a conductive pattern of liquid metal ink corresponding to the first electrode 100 may be formed on the dielectric substrate 50. Similarly, a conductive pattern of liquid metal ink corresponding to the second electrode 200 may be formed on the opposite surface of the dielectric substrate 50 using the same technique.

The liquid metal ink coated onto the dielectric substrate 50 may self-sinter as the solvent 110 contained in the slurry 125 evaporates, thereby forming a conductive pattern. In other words, the liquid metal ink is coated onto the dielectric substrate 50 in the form of a liquid ink and undergoes self-sintering without additional post-processing steps to form the first electrode 100 and the second electrode 200 of the flexible plasma generator.

FIG. 29 illustrates the self-sintering of the liquid metal slurry ink prepared in the slurry ink preparation step according to an embodiment of the present disclosure. Referring to FIGS. 2 and 29, as the solvent 110 begins to evaporate from the liquid metal ink coated onto the dielectric substrate 50, the liquid metal 120 in the slurry 125 may become uniformly mixed due to the solutal Marangoni effect during the initial stage of evaporation.

Moreover, as evaporation proceeds, the Laponite 135 particles may self-assemble on the surface of the liquid metal 120, forming a composite structured with liquid metal 120–polyvinylpyrrolidone (polymer 150)–water–Laponite 135–water. At this stage, the Laponite 135 layer formed on the surface of the liquid metal 120 may create multiple capillary bridges due to its hydrophilicity, which induce coalescence of the liquid metal 120 as a whole, resulting in the self-sintering behavior of the liquid metal ink. During this process, the liquid metal 120 particles in the applied ink may connect to form a conductive pattern.

Once the liquid metal ink self-sinters, a structure may be formed in which the liquid metal 120 particles are interconnected, as well as a structure in which the liquid metal 120 particles are connected via the Laponite 135 particles. The liquid metal 120 may sinter in the form of plural particles. Accordingly, a structure may be formed where the liquid metal 120 particles are directly interconnected, and in addition, a structure may be formed in which the liquid metal 120 particles are interconnected through the thickening agent 130 bonded to the surfaces of the liquid metal 120 (i.e., a structure in which the thickening agent 130 is interposed between the liquid metal 120 particles).

Furthermore, a structure may also be formed in which polyvinylpyrrolidone is interposed between the liquid metal 120 and the Laponite 135 particles. That is, a structure may be formed in which the polymer 150 is interposed between the liquid metal 120 and the thickening agent 130.

Hitherto, certain preferred embodiments of the present disclosure have been described, but it shall be appreciated by those of ordinary skill in the art to which the present disclosure pertains that various modifications, additions, deletions, or substitutions of components or elements may be made without departing from the technical ideas of the present disclosure as defined in the appended claims, and any such modifications, additions, deletions, or substitutions shall also fall within the scope of the present disclosure.

What is claimed is:

1. A flexible plasma generator comprising:
a dielectric substrate capable of elastic deformation;
a first electrode formed on one surface of the dielectric substrate and being deformable and restorable in accordance with deformation of the dielectric substrate; and
a second electrode formed on an opposite surface of the dielectric substrate and being deformable and restorable in accordance with deformation of the dielectric substrate,
wherein plasma is generated when an alternating current (AC) power source or a pulsed power source is applied to the first electrode and the second electrode.

2. The flexible plasma generator of claim 1, wherein the first electrode and the second electrode comprise:
liquid metal sintered in plural-particulate form; and
a thickening agent bonded to a surface of the liquid metal.

3. The flexible plasma generator of claim 2, wherein the first electrode and the second electrode are formed by coating the liquid metal in the form of an ink in a liquid state onto the dielectric substrate and allowing the liquid metal to self-sinter.

4. The flexible plasma generator of claim 2, the first electrode and the second electrode are formed in a single-layer structure, wherein the thickening agent is interposed between particles of the liquid metal.

5. The flexible plasma generator of claim 2, wherein a polymer is interposed between the liquid metal and the thickening agent.

6. The flexible plasma generator of claim 1, further comprising a substrate deformation unit configured to apply a physical force to the dielectric substrate, wherein the substrate deformation unit is configured to deform the dielectric substrate to vary an amount of plasma generated.

7. The flexible plasma generator of claim 6, wherein the substrate deformation unit comprises a pressure chamber configured to establish a pressure differential between the one surface and the opposite surface of the dielectric substrate to deform the dielectric substrate.

8. A method for manufacturing a flexible plasma generator, comprising:
a substrate placement step of positioning a dielectric substrate capable of elastic deformation;
a first electrode formation step of forming a first electrode on one surface of the dielectric substrate by applying a liquid metal slurry ink that self-sinters upon solvent evaporation; and
a second electrode formation step of forming a second electrode on an opposite surface of the dielectric substrate by applying the liquid metal slurry ink.

9. The method of claim 8, further comprising a slurry ink preparation step of preparing the self-sintering liquid metal slurry ink,
wherein the slurry ink preparation step comprises:
a liquid metal dispersion step of mixing liquid metal with the solvent to disperse the liquid metal in the solvent;
a composite formation step of adding a thickening agent to the solvent to form a composite of the liquid metal and the thickening agent; and
a slurry formation step of allowing the composite to settle to form a slurry.

10. The method of claim 9, further comprising an oxide layer removal step of removing an oxide layer from the liquid metal mixed in the solvent.

11. The method of claim 10, wherein the oxide layer removal step comprises adding an acid to the solvent.

12. The method of claim 9, further comprising a dispersion stabilization step of stabilizing dispersion of the liquid metal mixed in the solvent.

13. The method of claim 12, wherein the dispersion stabilization step comprises adding a polymer to control dispersibility of the dispersed liquid metal.

14. The method of claim 9, wherein the liquid metal dispersion step comprises a primary ultrasonic treatment step of dispersing the liquid metal by applying an ultrasonic treatment to the solvent.

15. The method of claim 14, further comprising a secondary ultrasonic treatment step of applying an ultrasonic treatment to the solvent before the slurry formation step.
